(19) United States
(12) Patent Application Publication
(10) Pub. No.: US 2026/0370626 A1
(43) Pub. Date: Nov. 19, 2026

(54) COLLISION RESPONSE FRAMES

(71) Applicant: Cisco Technology, Inc., San Jose, CA (US)

(72) Inventors: Jerome Henry, Pittsboro, NC (US); Domenico Ficara, Essertines-sur-Yverdon (CH); Javier Contreras, Barcelona (ES); Ugo Mario Campiglio, Morges (CH); Federico Lovison, Fontanelle (IT)

(21) Appl. No.: 19/677,533

(22) Filed: May 14, 2026

Related U.S. Application Data
(60) Provisional application No. 63/805,925, filed on May 14, 2025.

(51) Int. Cl. H04L 61/5046; H04L 61/5038; H04L 101/622; H04W 8/26; H04W 84/12

(52) U.S. Cl. CPC H04L 61/5046; H04L 61/5038; H04W 8/26; H04L 2101/622; H04W 84/12

(57) ABSTRACT

Collision response frames may be provided. A first computing device may determine that a second computing device is at risk of an Over-the-Air (OTA) Media Access Control (MAC) address collision. Next, the first computing device may transmit, to the second computing device in response to determining that the second computing device is at risk of the OTA MAC address collision, an OTA MAC collision notification frame that includes an OTA MAC collision notification warning element. Then the first computing device may receive, from the second computing device in response to transmitting the OTA MAC collision notification frame, an OTA MAC collision response frame that includes an OTA MAC collision response warning element.

### RELATED APPLICATION

Under provisions of 35 U.S.C. § 119(e), Applicant claims the benefit of U.S. Provisional Application No. 63/805,925, filed May 14, 2025, which is incorporated herein by reference.

### TECHNICAL FIELD

The present disclosure relates generally to providing collision response frames.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing collision response frames;

FIG. 2 is a flow chart of a method for providing collision response frames; and

FIG. 3 is a block diagram of a computing device.

### DETAILED DESCRIPTION

### Overview

Collision response frames may be provided. A first computing device may determine that a second computing device is at risk of an Over-the-Air (OTA) Media Access Control (MAC) address collision. Next, the first computing device may transmit, to the second computing device in response to determining that the second computing device is at risk of the OTA MAC address collision, an OTA MAC collision notification frame that includes an OTA MAC collision notification warning element. Then the first computing device may receive, from the second computing device in response to transmitting the OTA MAC collision notification frame, an OTA MAC collision response frame that includes an OTA MAC collision response warning element.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Over-the-Air (OTA) Media Access Control (MAC) collisions may occur when multiple wireless client devices simultaneously transmit data using the same MAC address or channel, causing packet interference. This may be increasingly relevant with randomized MAC addresses in Wi-Fi and mobile networks, where two devices might independently select the same MAC address within the same network, leading to transmission failures.

In the Institute of Electrical and Electronics Engineers (IEEE) 802.11bi, an AP may signal to a client device (i.e., a Station (STA)) or a non-AP Multi-Link Device (MLD) the risk of an OTA MAC collision with another client device on the same channel or link. In this situation, the AP may send an OTA MAC collision notification frame that includes an OTA MAC collision warning element, indicating an epoch at which the collision is likely to occur, and the number of epochs that the client device should skip to avoid the collision, thus using a MAC address expected for use in a later epoch. The client device may reply with an OTA MAC collision response frame that includes an OTA MAC collision response warning element. Embodiments of the disclosure may provide options for a client device to respond to the OTA MAC collision notification frame, providing several responses to avoid the collision without requiring a client device disconnection for example.

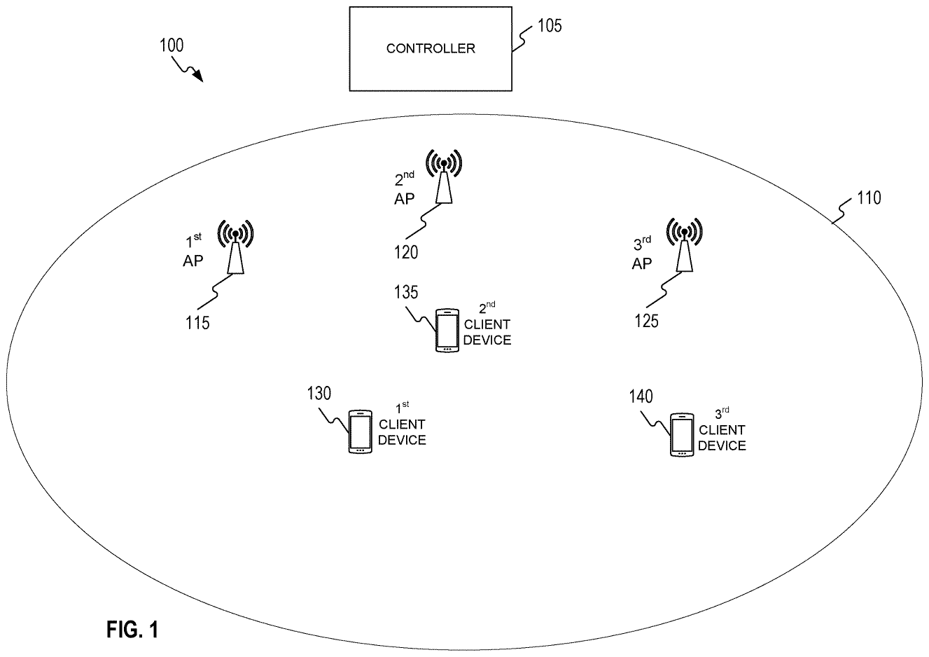

FIG. 1 shows an operating environment 100 for providing collision response frames. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. The plurality of client devices may comprise non-AP Multi-Link Devices (MLDs). Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi-Link Operation (MLO) where they simultaneously transmit and receive across different bands (or links) and channels by establishing two or more links to two or more AP radios. Accordingly, the plurality of APs and the plurality of client devices may comprise Multi-Link Devices (MLDs). These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

The 2.4 GHz band, the 5 GHz band, and the 6 GHz band may be referred together as the sub 7 GHz band. In addition to the sub 7 GHz band, embodiments of the disclosure may operate in the mmW band. The mmW band may refer to an extremely high-frequency spectrum band (e.g., between 30 GHz and 300 GHz, often 60 GHz) delivering multi-gigabit, low-latency, short-range, line-of-sight connectivity. The mmW band may enable ultra-fast, high-capacity wireless networks, acting, for example, for massive data in crowded places and for Fixed Wireless Access (FWA).

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide collision response frames.

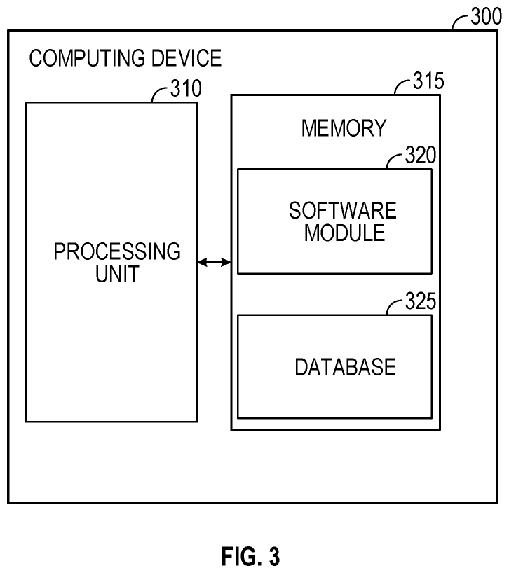

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

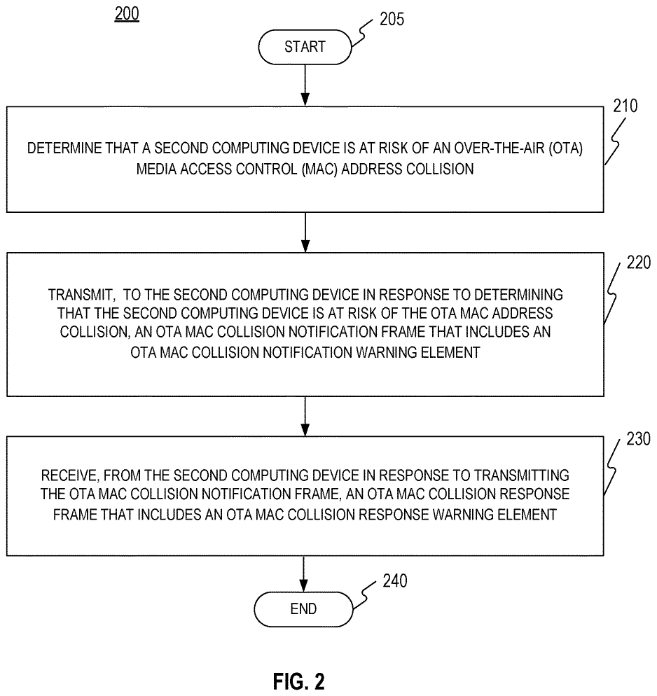

FIG. 2 is a flow chart setting forth the general stages involved in a method 200 consistent with embodiments of the disclosure for providing collision response frames. Method 200 may be implemented using computing device 300 as described in more detail below with respect to FIG. 3 that may be embodied by first AP 115 or first client device 130. Ways to implement the stages of method 200 will be described in greater detail below.

Method 200 may begin at starting block 205 and proceed to stage 210 where first AP 115 may determine that first client device 130 is at risk of an Over-the-Air (OTA) Media Access Control (MAC) address collision. For example, upon association, first AP 115 and first client device 130 and may agree on a process in which the OTA MAC address of first client device 130 may be randomized and rotated periodically at different epochs. Based on the agreed upon process, first AP 115 may then calculate future OTA MAC addresses for first client device 130 and other client devices associated with first AP 115 for given epochs and determine if any OTA MAC addresses for these client devices may be at risk of collision.

Second client device 135 may also be associated to first AP 115 and first AP 115 may also calculate future OTA MAC addresses for second client device 135. After doing an epoch-per-epoch comparison of the calculated future OTA MAC addresses for first client device 130 and the calculated future OTA MAC addresses for second client device 135, first AP 115 may discover that, for a future epoch, the OTA MAC address for first client device 130 and the OTA MAC address for second client device 135 may be the same thus creating a potential collision.

From stage 210, where first AP 115 determines that first client device 130 is at risk of an OTA MAC address collision, method 200 may advance to stage 220 where first AP 115 may transmit, to first client device 130 in response to determining that first client device 130 is at risk of the OTA MAC address collision, an OTA MAC collision notification frame that includes an OTA MAC collision notification warning element. For example, the OTA MAC collision notification warning element may indicate an epoch at which the collision is likely to occur, and the number of epochs that first client device should skip to avoid the collision (thus using a MAC address expected for use in a later epoch). An example format for the OTA MAC collision notification warning element and the OTA MAC collision response warning element are illustrated in Table 1 below.

TABLE 1

| | | | | | | | Non-AP MLD |
|---|---|---|---|---|---|---|---|
| | | | Element | | | | Specific Epoch |
| | Element | | ID | Collision | Colliding | Link ID | Number |
| | ID | Length | Extension | Status | Epoch | Info | Offset |
| Octets | 1 | 1 | 1 | 1 | 1 | 1 | 1 |

Once first AP 115 transmits, to first client device 130 in response to determining that first client device 130 is at risk of the OTA MAC address collision, the OTA MAC collision notification frame that includes the OTA MAC collision notification warning element in stage 220, method 200 may continue to stage 230 where first AP 115 may receive, from the second computing device in response to transmitting the OTA MAC collision notification frame, an OTA MAC collision response frame that includes an OTA MAC collision response warning element. The OTA MAC collision response warning element may comprise a similar format as that of the OTA MAC collision notification warning element shown in Table 1. For example, in one embodiment, first client device 130 may inform first AP 115 that it will comply or not comply with the parameters specified in the OTA MAC collision notification warning element in the OTA MAC collision notification frame. In that case, the OTA MAC collision response warning element's collision status field may include the value 1 (e.g., to accept first AP 115's suggestions) or the value 2 (e.g., to decline first AP 115's suggestion). The other fields in OTA MAC collision response warning element (e.g., colliding epoch, link identification (ID) info, and non-AP MLD specific epoch number offset) may be reserved.

In another embodiment, one option may be for first client device 130 to stay silent or in a dozing mode on the affected link during the target epoch where the collision may be expected. In this case, first client device 130 may return to first AP 115 an OTA MAC collision response warning element collision status field that may include the value 1 (e.g., to accept first AP 115's suggestions) or the value 2 (e.g., to decline first AP 115's suggestions) because either value may have the same effect.

In yet another embodiment, first client device 130 may return, in the OTA MAC collision response warning element's collision status field, a status 2 (i.e., declining first AP 115's suggestions), but may also want to suggest alternative options to first AP 115. In this case first client device 130 may propose to use the link MAC address it plans to use for the target epoch on another link that may be unaffected by the collision risk. Accordingly, first client device 130 may return, in the OTA MAC collision response warning element's collision status field, a value of 2 (i.e., to decline first AP 115's suggestions), but also may set the value of the colliding epoch to the value sent by first AP 115, and the link ID info field to indicate an ID of the link from which first client device 130 proposes to borrow its MAC address for that epoch. The non-AP MLD specific epoch number offset may be set to 0, indicating that the borrowed MAC address is the one expected for the affected epoch. In a variation, first client device 130 may indicate the MAC address of the other link, but for another epoch. First AP 115 may then conclude that the proposed MAC address may collide as well, and send a new OTA MAC collision notification frame. The token value may be similar to first client device 130's response, indicating that this is a new warning about the first client device 130's response.

In yet another embodiment, first client device 130 may prefer to keep using the MAC address it had in the epoch preceding the one where the collision is expected to occur. In this case, first client device 130's OTA MAC collision response warning element may include a collision status value to 2, the colliding epoch value may either be reserved or may set to the value indicated by first AP 115, the link ID info value may represent the value of the link on which the collision is expected, and the non-AP MLD specific epoch number offset value may be set to a number that represents the epoch previous to that of the expected collision. For example, the Most Significant Bit (MSB) may indicate a negative value, and the Least Significant Bit (LSB) may be the value 1, to represent that first client device will use the MAC address of the epoch −1 before the expected collision epoch. In a variation, the colliding epoch value may be set to the target epoch −1, and the non-AP MLD specific epoch number offset value may be set to 0.

As referenced above, first client device 130 may inform first AP 115 that it will not comply with the parameters specified in the OTA MAC collision notification warning element in the OTA MAC collision notification frame. In this case, the OTA MAC collision response warning element's collision status field may include the value 2 (e.g., to decline first AP 115's suggestion). In this case, first AP 115 may disassociate from first client device 130 in response for example. Once first AP 115 receives, from first client device 130 in response to transmitting the OTA MAC collision notification frame, the OTA MAC collision response frame that includes the OTA MAC collision response warning element in stage 230, method 200 may then end at stage 240.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing collision response frames as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining, by a first computing device, that a second computing device is at risk of an Over-the-Air (OTA) Media Access Control (MAC) address collision;
transmitting, by the first computing device to the second computing device in response to determining that the second computing device is at risk of the OTA MAC address collision, an OTA MAC collision notification frame that includes an OTA MAC collision notification warning element; and
receiving, by the first computing device from the second computing device in response to transmitting the OTA MAC collision notification frame, an OTA MAC collision response frame that includes an OTA MAC collision response warning element.

2. The method of claim 1, wherein the OTA MAC collision response warning element indicates that the second computing device accepts the OTA MAC collision notification warning element.

3. The method of claim 1, wherein the OTA MAC collision response warning element indicates that the second computing device rejects the OTA MAC collision notification warning element.

4. The method of claim 3, further comprising the first computing device disassociating the second computing device in response to the second computing device rejecting the OTA MAC collision notification warning element.

5. The method of claim 1, wherein the OTA MAC collision notification warning element indicates an epoch at which the OTA MAC address collision will occur and a number of epochs that the second computing device should skip to avoid the OTA MAC address collision.

6. The method of claim 5, wherein, in response to the second computing device determining to be silent during the epoch at which the OTA MAC address collision will occur, the OTA MAC collision response warning element indicates that the second computing device accepts the OTA MAC collision notification warning element.

7. The method of claim 5, wherein, in response to the second computing device determining to be silent during the epoch at which the OTA MAC address collision will occur, the OTA MAC collision response warning element indicates that the second computing device rejects the OTA MAC collision notification warning element.

8. The method of claim 5, wherein, in response to the second computing device determining to switch to a different link during the epoch at which the OTA MAC address collision will occur, the OTA MAC collision response warning element indicates that the second computing device rejects the OTA MAC collision notification warning element and will switch to the different link during the epoch at which the OTA MAC address collision will occur.

9. The method of claim 5, wherein, in response to the second computing device determining to keep using, for the epoch at which the OTA MAC address collision will occur, a MAC address used in an epoch preceding the epoch at which the OTA MAC address collision will occur, the OTA MAC collision response warning element indicates that the second computing device rejects the OTA MAC collision notification warning element and will keep using, for the epoch at which the OTA MAC address collision will occur, the MAC address used in the epoch preceding the epoch at which the OTA MAC address collision will occur.

10. A system comprising:
a memory storage; and
a processing unit disposed in a first computing device and coupled to the memory storage, wherein the processing unit is operative to:
determine that a second computing device is at risk of an Over-the-Air (OTA) Media Access Control (MAC) address collision;
transmit to the second computing device in response to determining that the second computing device is at risk of the OTA MAC address collision, an OTA MAC collision notification frame that includes an OTA MAC collision notification warning element; and
receive from the second computing device in response to transmitting the OTA MAC collision notification frame, an OTA MAC collision response frame that includes an OTA MAC collision response warning element.

11. The system of claim 10, wherein the OTA MAC collision response warning element indicates that the second computing device accepts the OTA MAC collision notification warning element.

12. The system of claim 10, wherein the OTA MAC collision response warning element indicates that the second computing device rejects the OTA MAC collision notification warning element.

13. The system of claim 12, wherein the processing unit is further operative to cause the first computing device to disassociate the second computing device in response to the second computing device rejecting the OTA MAC collision notification warning element.

14. The system of claim 10, wherein the OTA MAC collision notification warning element indicates an epoch at which the OTA MAC address collision will occur and a number of epochs that the second computing device should skip to avoid the OTA MAC address collision.

15. A non-transitory computer-readable medium that stores a set of instructions which when executed perform a method executed by the set of instructions comprising:
determining, by a first computing device, that a second computing device is at risk of an Over-the-Air (OTA) Media Access Control (MAC) address collision;
transmitting, by the first computing device to the second computing device in response to determining that the second computing device is at risk of the OTA MAC address collision, an OTA MAC collision notification frame that includes an OTA MAC collision notification warning element; and
receiving, by the first computing device from the second computing device in response to transmitting the OTA MAC collision notification frame, an OTA MAC collision response frame that includes an OTA MAC collision response warning element.

16. The non-transitory computer-readable medium of claim 15, wherein the OTA MAC collision notification warning element indicates an epoch at which the OTA MAC address collision will occur and a number of epochs that the second computing device should skip to avoid the OTA MAC address collision.

17. The non-transitory computer-readable medium of claim 16, wherein, in response to the second computing device determining to be silent during the epoch at which the OTA MAC address collision will occur, the OTA MAC collision response warning element indicates that the second computing device accepts the OTA MAC collision notification warning element.

18. The non-transitory computer-readable medium of claim 16, wherein, in response to the second computing device determining to be silent during the epoch at which the OTA MAC address collision will occur, the OTA MAC collision response warning element indicates that the second computing device rejects the OTA MAC collision notification warning element.

19. The non-transitory computer-readable medium of claim 16, wherein, in response to the second computing device determining to switch to a different link during the epoch at which the OTA MAC address collision will occur, the OTA MAC collision response warning element indicates that the second computing device rejects the OTA MAC collision notification warning element and will switch to the different link during the epoch at which the OTA MAC address collision will occur.

20. The non-transitory computer-readable medium of claim 16, wherein, in response to the second computing device determining to keep using, for the epoch at which the OTA MAC address collision will occur, a MAC address used in an epoch preceding the epoch at which the OTA MAC address collision will occur, the OTA MAC collision response warning element indicates that the second computing device rejects the OTA MAC collision notification warning element and will keep using, for the epoch at which the OTA MAC address collision will occur, the MAC address used in the epoch preceding the epoch at which the OTA MAC address collision will occur.
